(19) United States
(12) Patent Application Publication
(10) Pub. No.: US 2013/0100423 A1
(43) Pub. Date: Apr. 25, 2013

(54) LIGHTING DEVICE

(71) Applicant: Panasonic Corporation, Osaka (JP)

(72) Inventors: Shigekazu YAMAGISHI, Osaka (JP); Atsushi Motoya, Shiga (JP); Hiroshi Kitano, Hyogo (JP); Hiroki Sugiyama, Osaka (JP)

(73) Assignee: Panasonic Corporation, Osaka (JP)

(21) Appl. No.: 13/654,375

(22) Filed: Oct. 17, 2012

(30) Foreign Application Priority Data
Oct. 20, 2011 (JP) 2011-230502
Sep. 13, 2012 (JP) 2012-201371

(51) Int. Cl. F21V 7/04; G03B 21/28

(52) U.S. Cl. 353/98; 362/282; 362/84; 362/259

(57) ABSTRACT

There are provided a lighting device with which it is possible to avoid the problem of heat generation in parts subjected to the concentrated energy of irradiating light even when the parts are irradiated with high-energy light from a light source, and a projection type of image display device equipped with this lighting device. This lighting device comprises a light source and a rotary reflecting member that is disposed at an angle to light incident from the light source. The rotary reflecting member has on its periphery a portion that reflects incident light (first region) and a portion that does not reflect (second region).

### BACKGROUND

1. Field of the Invention

The present disclosure relates to a lighting device which utilizes light obtained by the excitation of a fluorescent material with excitation light, or blue light that is excitation light, as its light source light and can successively switch among different colors of light, and to a projection type of image display device in which this lighting device is used.

2. Current State of the Art

Ultrahigh pressure mercury lamps have been used in the past as the light source in projection image display devices. An ultrahigh pressure mercury lamp has a short service life (output half-life) of about 2000 hours, and also makes use of mercury, which is a hazardous substance, and because of this there is a move toward using solid-state light sources.

However, with an LED, which is a solid-state light source, there is a limit to the output per unit of surface area, and while it can be used for products with low brightness, it cannot be applied to products that need high brightness.

Given this situation, in recent years we have begun to see products on the market with which a practical light output is obtained by using a plurality of blue laser beams as the excitation light source and disposing a fluorescent material in a collector that converges these laser beams by an optical means. A configuration such as this affords high-output green light that is particularly difficult to obtain with a light emitting diode (LED).

As shown in FIG. 15, with a conventional lighting device, light from a light source 701 is converged by an optical system 702, and a motor M rotates a fluorescent wheel 703 in which the collector is coated with a fluorescent material. This wheel is divided up into a plurality of fan-shaped sections whose center is the rotational axis. The divided portions are processed to impart different actions with respect to incident light, such as different fluorescent materials or transmission parts. Consequently, different colors of light can be given successively to the image display element (see U.S. Pat. No. 7,547,114, for example).

Japanese Patent 4,756,403 and 3 disclose a constitution which comprises a light source that emits excitation light, and a rotating wheel that is coated with two or more fluorescent materials having different properties in different regions at the positions where the light is incident, and in which this fluorescent light, or excitation light that has been transmitted or reflected, is guided to an image display element to perform a color display.

Furthermore, in recent years lighting devices have been used in which fluorescent materials corresponding to the three primary colors (R, G, B) are disposed on a single fluorescent wheel.

### SUMMARY

A lighting device of this disclosure comprises a light source and a rotary reflecting member comprising a first region that reflects light and a second region that does not reflect light. The rotary reflecting member is disposed at an angle such that an incident face of the reflecting member coincides with light from the light source and rotates in respect to the light.

### BRIEF DESCRIPTION OF DRAWINGS

FIG. 1 is a diagram of the configuration of a lighting device pertaining to Embodiment 1 of this disclosure;

FIG. 2 is a front view of a rotary reflecting plate included in the lighting device in FIG. 1;

FIG. 3 is a diagram of the configuration of a projection type of image display device pertaining to Embodiment 2 of this disclosure;

FIG. 4 is a front view of a rotary reflecting plate included in the projection image display device in FIG. 3;

FIG. 5 is a front view of a fluorescent wheel included in the projection image display device in FIG. 3;

FIG. 6 is a diagram of the configuration of a lighting device pertaining to Embodiment 3 of this disclosure;

FIG. 7 is a front view of a rotary reflecting plate included in the lighting device in FIG. 6;

FIG. 8 is a diagram illustrating the relation between the rotary reflecting plate and the incident light position in the lighting device in FIG. 6;

FIG. 9 is a diagram of a first example of a lighting device pertaining to Embodiment 4 of this disclosure;

FIG. 10 is a diagram of a second example of a lighting device pertaining to Embodiment 4 of this disclosure;

FIG. 11 is a diagram of the configuration of a lighting device pertaining to Embodiment 5 of this disclosure;

FIG. 12 is a diagram illustrating the relation between the rotary reflecting plate and the incident light position in the lighting device in FIG. 11;

FIG. 13 is a diagram of a first application example of a four-branch configuration of the lighting device in FIG. 11;

FIG. 14 is a diagram of a second application example of a four-branch configuration of the lighting device in FIG. 11; and

FIG. 15 is a diagram of the configuration of a conventional lighting device.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### Embodiment 1

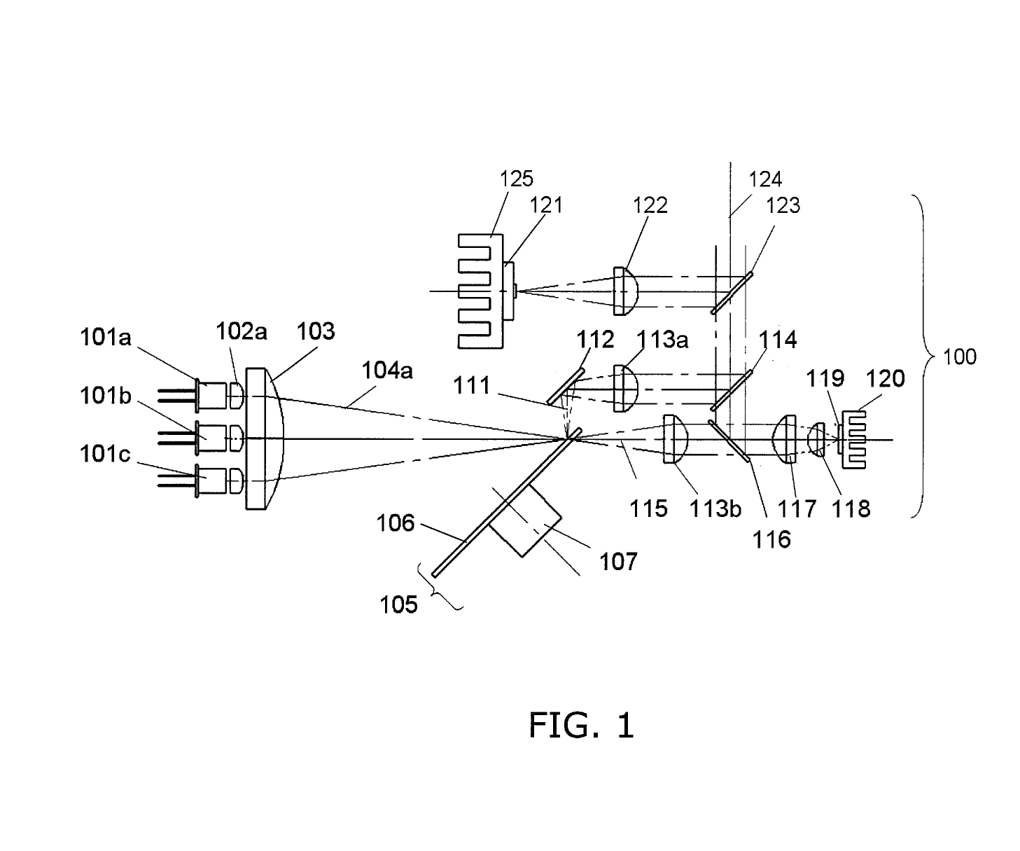

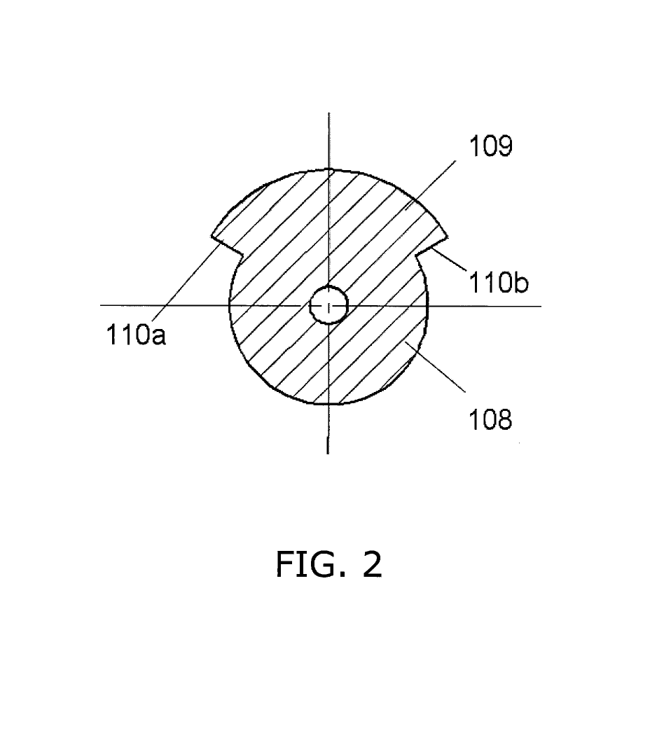

FIG. 1 is a diagram of the configuration of a lighting device 100 pertaining to Embodiment 1 of this disclosure. FIG. 2 is a front view of a rotary reflecting plate installed in the lighting device shown in FIG. 1.

With the lighting device 100, a laser light source is used as the light source. In particular, in this embodiment, semiconductor lasers 101a, 101b, and 101c with a central wavelength of 445 nm are used.

Collimating lenses 102a, 102b, and 102c that convert the laser light into substantially parallel beams are disposed near the semiconductor lasers 101a, 101b, and 101c. The light emitted from the collimating lenses 102a, 102b, and 102c is incident on a converging lens 103 and converged on a rotary reflecting plate 106 of an incident light switching mechanism 105.

The rotary reflecting plate 106 is connected to a motor 107. The rotary reflecting plate 106 is rotated by the rotational drive force of the motor 107, with its center as the rotational axis. As shown in FIG. 2, the rotary reflecting plate 106 also has a rotary reflecting plate small-diameter part (second region) 108 that has no effect on the progress of incident light, and a rotary reflecting plate large-diameter part (first region) 109 that reflects incident light.

The rotary reflecting plate large-diameter part 109 has a shape in a plan view of the rotary reflecting plate 106 in which the rotational center of the rotary reflecting plate 106 is disposed along extensions of ends 110a and 110b. The light emitted from the light source is incident on a peripheral part that includes the ends 110a and 110b.

The light beams emitted from the semiconductor lasers here have different divergence angles depending on the direction. The semiconductor lasers 101a, 101b, and 101c are constituted so that the radial direction of the rotary reflecting plate 106 coincides with the direction in which these divergence angles increase (a light source image extending in the rotational center direction). Furthermore, the surface of the rotary reflecting plate 106 has a textured shape that diffuses incident light to make it weaker.

When light is incident on the rotary reflecting plate large-diameter part 109 at an angle, the light that is reflected moves to the optical axis 111. The light beams reflected by a reflecting mirror 112 are converted by a collimating lens 113a into substantially parallel beams, after which they reach a blue-reflecting dichroic mirror 114. Up to this point the light from the light source is 445 nm, so it is reflected by the blue-reflecting dichroic mirror 114.

Meanwhile, when the rotary reflecting plate 106 rotates until the rotary reflecting plate small-diameter part 108 moves to the incident position of light, there is nothing to impede the incident light. Accordingly, the incident light passes straight through, and the beams move to the optical axis 115 and are converted by a collimating lens 113b into substantially parallel beams, after which they reach a blue-transmitting and green-reflecting dichroic mirror 116.

As mentioned above, the light from the light source up to this point is 445 nm. Accordingly, it passes through the blue-transmitting and green-reflecting dichroic mirror 116 and is made by a first condenser lens 117 and a second condenser lens 118 to be incident on a green fluorescent chip (fluorescent component) 119.

The green fluorescent chip 119 is formed by baking and solidifying a fluorescent material that emits green light upon receiving blue light, and has a reflective layer on its rear face. This reflective layer and a heat diffuser 120 are connected via a thermally conductive material. The green light beams emitted from the green fluorescent chip 119 upon receipt of the incident light go through the second condenser lens 118 and the first condenser lens 117 and are made into substantially parallel beams, after which they are reflected by the blue-transmitting and green-reflecting dichroic mirror 116.

For red light, a red LED 121 that emits red light is used.

The light beams emitted from the red LED 121 are converted by a third condenser lens 122 into substantially parallel beams, after which they are incident on and reflected by a red-reflecting dichroic mirror 123. The red LED 121 here is connected to a heat diffuser 125 via a thermally conductive material.

Thus, red, green, and blue (RGB) light can be superposed on the optical axis 124, so the lighting device 100 can provide illumination light that makes color video possible.

Let us assume that the system is controlled so that the semiconductor lasers 101a, 101b, and 101c are extinguished when the red LED 121 is lit.

The functions of the above-mentioned components will now be described.

In this embodiment an example was described in which semiconductor lasers with a central wavelength of 445 nm were used, but the present disclosure is not limited to or by this. For example, as long as the wavelength is one that can excite the fluorescent material of the green fluorescent chip 119 and can be perceived as blue light, then light having some other central wavelength may be used instead with no problem.

Also, in this embodiment three semiconductor lasers were used, but that number can be increased or decreased as needed.

In this embodiment the blue light was the laser beam itself, so there is a spectrum when it is emitted just as it is. In view of this, in this embodiment the surface of the rotary reflecting plate 106 is given a textured shape that diffuses the incident light to make it weaker. When the rotary reflecting plate 106 rotates while diffusing and reflecting the incident light, the coherence of the laser is disrupted, allowing the generation of a spectrum to be greatly suppressed.

Furthermore, it is possible to use an LED having a similar wavelength instead of a semiconductor laser as the excitation source. To ensure the proper brightness per unit of surface area of the irradiated face while illuminating the fluorescent material, however, it is preferable to use a laser with a smaller light emitting component that makes it easier to converge light.

The incident light switching mechanism 105 uses a sensor (not shown) to detect the position of the rotary reflecting plate 106. In this example, as discussed above, the system is controlled so that the semiconductor lasers 101a, 101b, and 101c are extinguished for part of the time when the rotary reflecting plate small-diameter part 108 is in the incident position, which has no effect on the progress of incident light at the rotary reflecting plate 106, while the red LED 121 is lit.

The green fluorescent chip 119 is generally configured such that it does not make use of an organic material for a binder, and instead has the fluorescent material kneaded into glass, and is preferably constituted as a single crystal of fluorescent material or a polycrystal of a fluorescent material (see Japanese Laid-Open Patent Application 2011-129354, etc.). Consequently, with either constitution, the resulting fluorescent chip will have better heat resistance than a type that makes use of a resin as a binder. With this constitution, only simple cooling need be performed, even when using a fluorescent material that is disposed in a fixed position, rather than a rotating body such as a fluorescent wheel.

With this embodiment, an example was described in which the red LED 121 was cooled by the heat diffuser 125 connected to the red LED 121, but the present disclosure is not limited to or by this.

For instance, when an LED with a large output is used, this can be accommodated by providing a liquid-cooled system (which uses a liquid as a coolant) on the rear face. Similarly, the heat diffuser 120 of the green fluorescent chip 119 may be replaced with a liquid-cooled system.

Also, in this embodiment, blue light is obtained by diffusing the light of a semiconductor laser, but the configuration may be such that blue light is obtained by using a shorter laser wavelength and providing a fluorescent material that emits blue light when this laser light is used as the excitation source.

As discussed above, with this embodiment, light from a light source at just one location can be switched at high speed to different optical paths over time. This means that different colors of light can be sequentially provided as the lighting device output.

In particular, the rotary reflecting plate 106 of the incident light switching mechanism 105 is preferably formed by a highly reflective layer made of an inorganic material on a ceramic substrate (such as glass) or a metal plate having high reflectivity. This suppresses heat generation at the rotary reflecting plate 106. Thus, there will be no problem with reliability of the motor 107 even when handling high-output light.

As to ease of working, since this product can be produced with existing, simple technology, an inexpensive rotary reflecting plate can be obtained.

### Embodiment 2

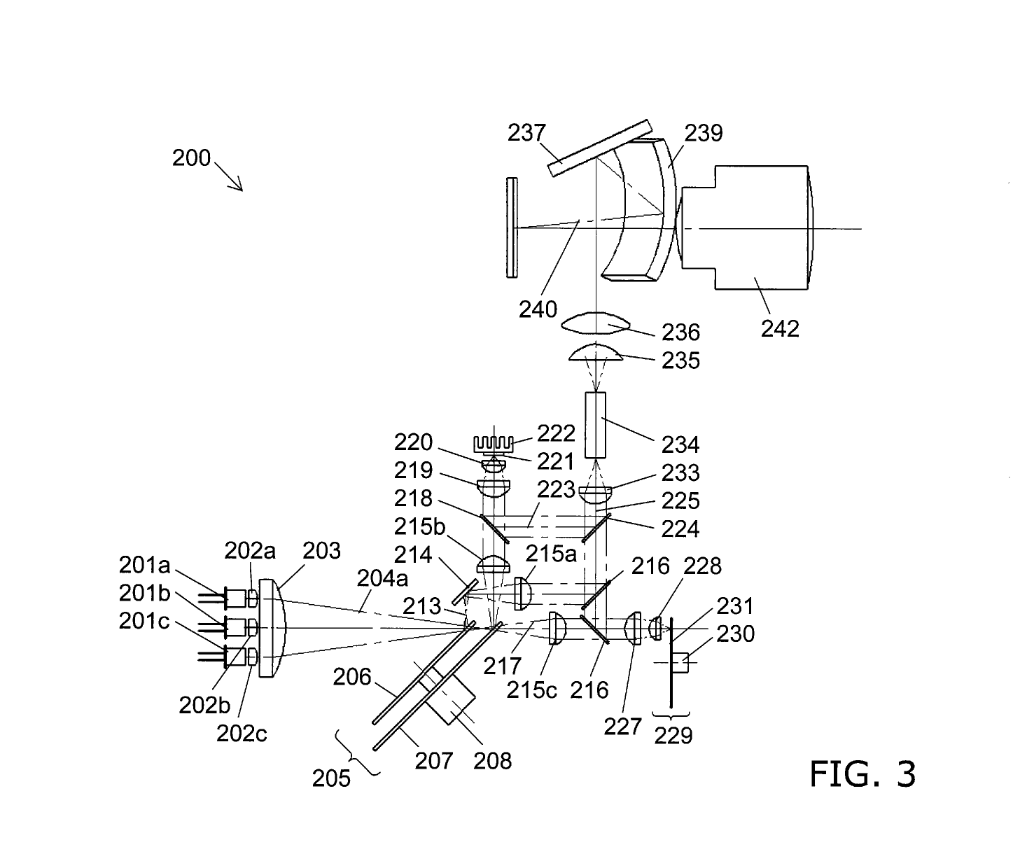

The projection type of image display device pertaining to another embodiment of the present disclosure will now be described through reference to FIGS. 3 to 5.

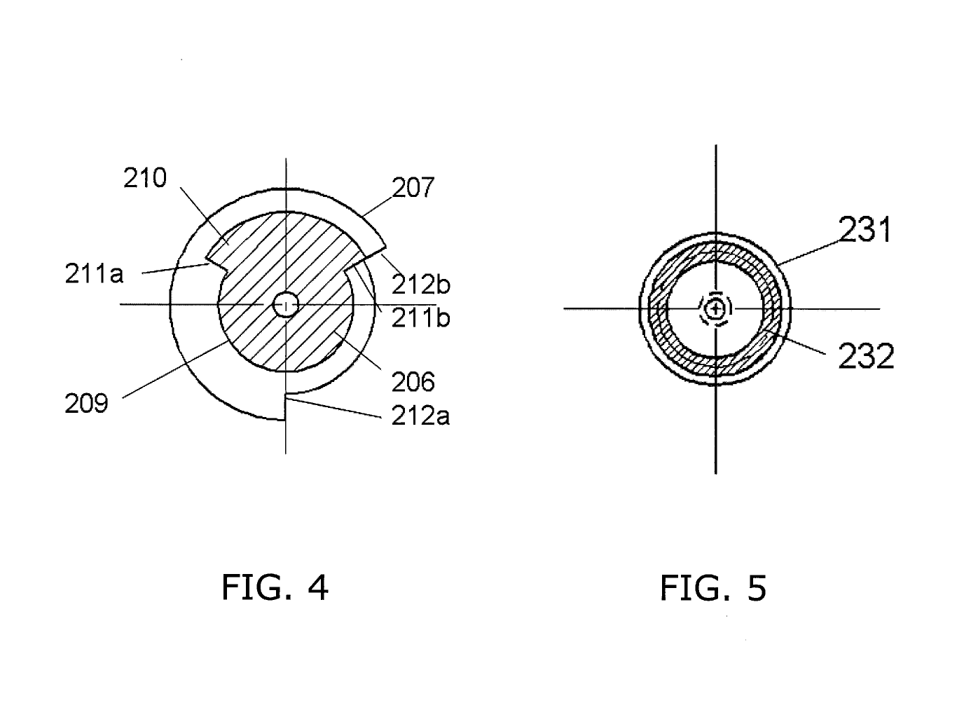

FIG. 3 is a diagram of the configuration of a projection type of image display device pertaining to Embodiment 2 of this disclosure. FIG. 4 is a front view of a rotary reflecting plate included in the projection image display device in FIG. 3. FIG. 5 is a front view of a fluorescent wheel.

Just as in Embodiment 1 above, the light sources are semiconductor lasers 201a, 201b, and 201c with a central wavelength of 445 nm.

Collimating lenses 202a, 202b, and 202c that convert the laser light into substantially parallel beams are disposed near the semiconductor lasers 201a, 201b, and 201c. The light emitted from these lenses is incident on a converging lens 203 and converged between rotary reflecting plates 206 and 207 of an incident light switching mechanism 205.

The rotary reflecting plates 206 and 207 (first and second reflective members, respectively) are connected to a motor 208 such that there is no change in their mutual positional relation, and rotate under the rotary drive force of the motor 208, with the center thereof as the rotational axis.

As shown in FIG. 4, the rotary reflecting plate 206 has a rotary reflecting plate small-diameter part (second region) 209 that has no effect on the progress of incident light, and a rotary reflecting plate large-diameter part (first region) 210 that reflects incident light. The ends 211a and 211b of the rotary reflecting plate large-diameter part 210 have a shape such that the rotational center of the rotary reflecting plate 206 is disposed along extensions of these ends.

The light emitted from the light source is incident on a peripheral part that is perpendicular to the ends 211a and 211b. The light beams emitted from the semiconductor lasers 201a, 201b, and 201c have different divergence angles depending on the direction. The semiconductor lasers 201a, 201b, and 201c are disposed so that the direction in which these divergence angles increase substantially coincides with the direction of the shape of the two ends 210a and 210b. Furthermore, the surface of the rotary reflecting plate 206 has a textured shape that diffuses incident light to make it weaker.

The light beams that are incident on the rotary reflecting plate large-diameter part 210 of the rotary reflecting plate 206 are reflected here and proceed to the optical axis 213. The light beams reflected by a reflecting mirror 214 are converted by a collimating lens 215a into substantially parallel beams, after which they reach a blue-reflecting dichroic mirror 216. Up to this point the light from the light source is 445 nm, so it is reflected by the blue-reflecting dichroic mirror 216 as shown in FIG. 3.

When the rotary reflecting plate small-diameter part 209 moves to the incident position of light, there is nothing to impede the incident light. Thus, the incident light passes straight through and reaches a rotary reflecting plate 207.

As shown in FIG. 4, the light from the light source incident over a range of from the end 211a of the rotary reflecting plate 206 to the end 212a of the rotary reflecting plate 207 in the counter-clockwise direction is incident on the rotary reflecting plate 207 at an angle.

The rotary reflecting plate 207 is made of a material with high reflectivity. Accordingly, the incident light here is reflected and proceeds along the optical axis 217.

The light beams incident on a collimating lens 215b are converted into substantially parallel beams, after which they are incident on and transmitted by a blue-transmitting and green-reflecting dichroic mirror 218, and are made by a first condenser lens 219 and a second condenser lens 220 to be incident on a green fluorescent chip (fluorescent component) 221.

The green fluorescent chip 221 has the same configuration as the green fluorescent chip 119 in Embodiment 1 above. Thus, the green fluorescent chip 221 is also formed by baking and solidifying a fluorescent material that emits green light upon receiving blue light, and has a reflective layer on its rear face.

This reflective layer and a heat diffuser 222 are connected via a thermally conductive material.

The green light beams emitted from the green fluorescent chip 221 upon receipt of the incident light go through the second condenser lens 220 and the first condenser lens 219 and are made into substantially parallel beams, after which they are reflected by the blue-transmitting and green-reflecting dichroic mirror 218, proceed in the direction of the optical axis 223, and are incident on a blue- and red-transmitting and green-reflecting dichroic mirror 224. The green light incident on the blue- and red-transmitting and green-reflecting dichroic mirror 224 is reflected and proceeds in the direction of the optical axis 225.

If the light from the light source is incident over a range of from the end 212a of the rotary reflecting plate 207 to the end 212b disposed in the counter-clockwise direction shown in FIG. 4, it will move straight ahead, without being reflected by the rotary reflecting plate 207.

The light beams incident on a collimating lens 215c are converted into substantially parallel beams, are incident on and transmitted by a blue-transmitting and red-reflecting dichroic mirror 226, and are incident on a red fluorescent wheel (fluorescent component) 229 via a first condenser lens 227 and a second condenser lens 228.

The red fluorescent wheel 229 is constituted by applying a red fluorescent material 232 in an annular shape over a disk 231 formed by a material with high reflectivity and high thermal conductivity and rotated by a motor 230. The red light beams emitted from the red fluorescent wheel 229 upon receipt of incident light go through the second condenser lens 228 and the first condenser lens 227 and become substantially parallel beams, after which they are reflected by the blue-transmitting and red-reflecting dichroic mirror 226.

As discussed above, the blue, green, and red light beams are combined in the direction of the optical axis 225, after which this product is made by a rod converging lens 233 to be incident on a rod integrator 234 (a cuboid piece of glass), and is emitted after repeated superposed reflection on the inner face of the rod integrator 234. The light that is transmitted by relay lenses 235 and 236 and reflected by a flat mirror 237 proceeds along the optical axis 240 and is converged by a converging mirror 239 on an image display element 241. A DMD (digital mirror device) is used as the image display element 241 here.

The DMD 241 is constituted by disposing microscopic mirrors two-dimensionally. The inclination of each of the micro mirrors is varied according to an input signal.

For example, the light incident on the micro mirrors disposed on pixels that give a white display is incident on a projecting lens 242 and reaches a screen (not shown) because the micro mirrors fall in the direction in which the incidence angle becomes smaller.

Meanwhile, the light incident on the micro mirrors disposed on pixels that give a black display in the image display element 241 is reflected and guided to the projecting lens 242 because the micro mirrors fall in the direction in which the incidence angle becomes larger. Consequently, those pixels give a black display on the screen. Furthermore, to obtain a black display, an image of red, green, and blue is displayed at least once per field.

This image display control is carried out while synchronizing with the rotation of the rotary reflecting plates 206 and 207 of the incident light switching mechanism 205.

In this embodiment, just as in Embodiment 1 above, the rotary reflecting plates 206 and 207 may be formed by a reflective material in a pattern with the necessary shape over a disk made of a transparent material, rather than the method of obtaining an external shape discussed above.

For instance, the rotary reflecting plates 206 and 207 may be replaced by forming a reflective layer with a multilayer film that efficiently reflects light of 445 nm (the semiconductor laser wavelength) so as to obtain the same shape as that of the rotary reflecting plates 206 and 207.

Also, a rotary wheel is used for the red fluorescent material in this embodiment, but it is preferable to use an aluminum plate or other such material with excellent thermal conductivity as the material for the wheel. This allows the wheel formed from an aluminum plate or the like to be cooled by rotating the wheel.

Furthermore, this expands the peripheral surface area over which excitation light is received, so a decrease in conversion efficiency, degradation, and the like attributable to heat generated when excitation light is received can be suppressed, and the fluorescent material can be selected from a broader range.

This applies not only to red fluorescent materials, but also to green fluorescent materials. Furthermore, a fluorescent material can be obtained for blue light using a semiconductor laser wavelength of about 400 nm.

Also, the optical path reflected by the rotary reflecting plate 206 was blue, but the present disclosure is not limited to or by this.

For example, the optical path reflected by the surface of the rotary reflecting plate 207 may be blue. In this case, it is preferable to impart a diffusion action to the surface of the rotary reflecting plate 207.

Also, the blue optical path may be substituted with the red optical path in this embodiment. In this case, though, there will be no diffusion effect by the rotary reflecting face, so a separate diffusion plate is preferably provided.

An example was described in which a DMD was used as an image display element, but the present disclosure is not limited to or by this.

For instance, a device that allows the display of an image to be switched according to a color signal at high speed may be used, such as a liquid crystal device with a thinner liquid crystal layer that is compatible with high speed, a liquid crystal device featuring a material that allows high-speed operation, such as a dispersion type of liquid crystal, or a MEMS device such as a GLV (grating light value).

### Embodiment 3

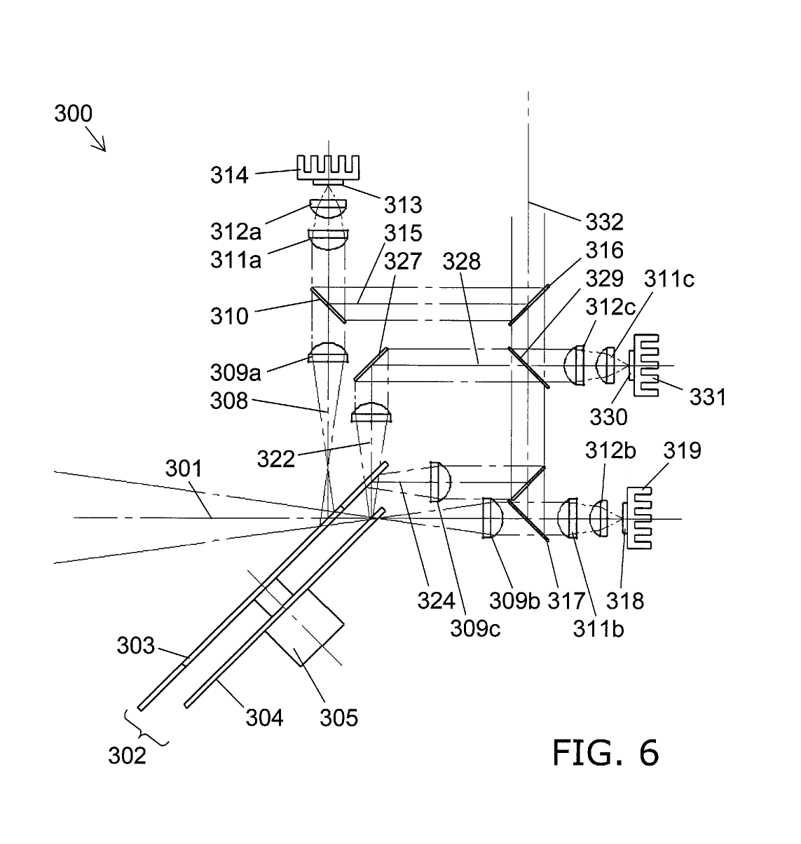

The lighting device pertaining to yet another embodiment of the present disclosure will now be described through reference to FIGS. 6 to 8d.

The lighting device in this embodiment is similar to that in Embodiment 2 above in that it has a configuration featuring two rotary reflecting plates, but as shown in FIG. 6, optical path branching is performed in four directions.

Furthermore, the light source (not shown) is semiconductor lasers with a central wavelength of 445 nm, just as in Embodiments 1 and 2.

Light beams emitted from the light source pass along the optical axis 301 and are incident on an incident light switching mechanism 302 that is disposed at an angle to this axis.

The incident light switching mechanism 302 is connected to a motor 305 such that there is no change in the mutual positional relation between rotary reflecting plates 303 and 304, and is rotated by the rotational drive force of a motor (not shown) whose rotational axis is the center thereof.

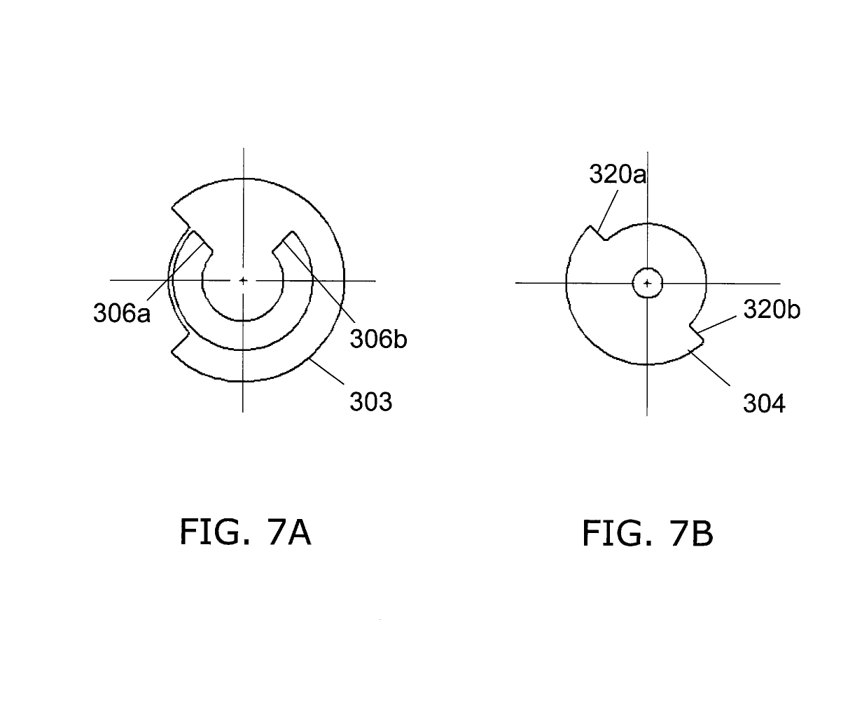

FIG. 7a is a front view of the rotary reflecting plate 303. The rotary reflecting plate 303 has a cut-out between ends 306a and 306b that does not affect the progress of incident light, and a partial cut-out formed in the large-diameter part.

FIG. 7b is a front view of the rotary reflecting plate 304. The rotary reflecting plate 304 has a small-diameter part that does not intersect the optical axis 301 (does not affect the progress of incident light), and a partial cut-out formed in the large-diameter part that intersects the optical axis 301 (reflects incident light). The rotary reflecting plates 303 and 304 are each formed by an aluminum plate that has undergone high reflection processing.

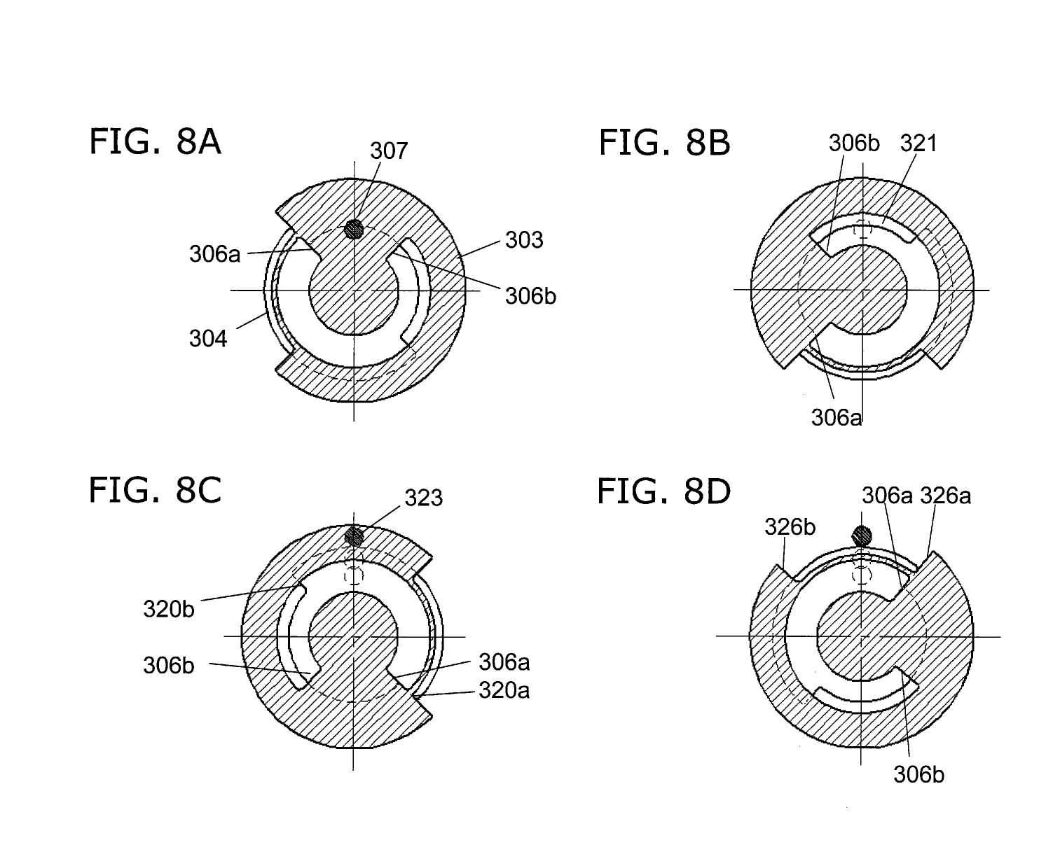

A case in which the positional relation between the incident light and the rotary reflecting plates 303 and 304 is shown in FIG. 8a will now be described.

As shown in FIG. 8a, the incident light is reflected by being incident at a reflective face position 307 on the rotary reflecting plate 303, and proceeds along the optical axis 308. Light beams that are incident on a collimating lens 309a are converted into substantially parallel beams and are incident on and transmitted by a blue-transmitting and red-reflecting dichroic mirror 310, and then go through a first condenser lens 311a and a second condenser lens 312a and are incident on a red fluorescent chip (fluorescent component) 313.

The red fluorescent chip 313 has the same configuration as the green fluorescent chip in Embodiments 1 and 2 above. That is, the red fluorescent chip 313 is also formed by baking and solidifying a fluorescent material that emits red light upon receiving blue light, and has a reflective layer on its rear face. This reflective layer and a heat diffuser 314 are connected via a thermally conductive material.

The red light beams emitted upon receipt of the incident light go through the second condenser lens 312a and the first condenser lens 311a and are made into substantially parallel beams, after which they are reflected by the blue-transmitting and red-reflecting dichroic mirror 310, proceed in the direction of the optical axis 315, and are incident on and reflected by a red-reflecting dichroic mirror 316.

Next, the positional relation between incident light and the rotary reflecting plates 303 and 304 will be described for the case shown in FIG. 8b.

As shown in FIG. 8b, the incident light passes through the cut-out between the ends 306a and 306b on the rotary reflecting plate 303, and is incident for the small-diameter period of the rotary reflecting plate 304, thereby passing through the incident light switching mechanism 302.

Since FIG. 8b is a front view, it appears as if part of the incident light is reflected by the small-diameter part of the rotary reflecting plate 304, but actually it is incident at an angle, and therefore goes through a transmission part 321, which is a gap.

The light incident on the collimating lens 309b is converted into substantially parallel light, after which it is incident on and transmitted by a blue-transmitting and yellow-reflecting dichroic mirror 317, goes through a first condenser lens 311b and a second condenser lens 312b, and is incident on a yellow fluorescent chip (fluorescent component) 318.

The yellow fluorescent chip 318 has the same configuration as the other fluorescent chips. That is, the yellow fluorescent chip 318 is produced by mixing an inorganic binder with a fluorescent material that emits yellow light upon the receipt of blue light, and coating a substrate with this mixture, and a reflective layer is provided to the rear face side of this substrate.

The reflective layer and a heat diffuser 319 are connected via a thermally conductive material. The yellow light beams emitted from the yellow fluorescent chip 318 upon receipt of the incident light go through the second condenser lens 312b and the first condenser lens 311b and are made into substantially parallel beams, after which they are reflected by the blue-transmitting and yellow-reflecting dichroic mirror 317.

Next, the positional relation between incident light and the rotary reflecting plates 303 and 304 will be described for the case shown in FIG. 8c.

As shown in FIG. 8c, the incident light passes through the cut-out between the ends 306a and 306b on the rotary reflecting plate 303, and is reflected by being incident on the large-diameter part between the ends 320a and 320b of the rotary reflecting plate 304. The incident light then proceeds along the optical axis 322, is incident on the back face side of the rotary reflecting plate 303, is further reflected there, and proceeds along the optical axis 324.

The back side of the rotary reflecting plate 303 here is formed with a textured shape that diffuses the incident light to make it weaker. Thus, the light incident on the collimating lens 309c is converted into substantially parallel light, after which it is incident on and reflected by a blue-reflecting dichroic mirror 325.

Next, the positional relation between incident light and the rotary reflecting plates 303 and 304 will be described for the case shown in FIG. 8d.

As shown in FIG. 8d, the incident light passes through the cut-out between the ends 306a and 306b on the rotary reflecting plate 303, is reflected by being incident on the large-diameter portion between the ends 320a and 320b of the rotary reflecting plate 304, and proceeds along the optical axis 322. At this point, since the incident light is incident on the cut-out between the ends 326a and 326b of the rotary reflecting plate 303, it is incident on the collimating lens 309d without being blocked.

The light beams converted into substantially parallel light by the collimating lens 309d is reflected by the total reflecting mirror 327, proceeds along the optical axis 328, is incident on and transmitted by a blue-transmitting and green-reflecting dichroic mirror 329, goes through a first condenser lens 311c and a second condenser lens 312c, and is incident on a green fluorescent chip (fluorescent component) 330.

The green fluorescent chip 330 has the same configuration as what was described in Embodiments 1 and 2 above, and will therefore not be described again.

The green light emitted from the green fluorescent chip 330 upon receipt of incident light goes through the second condenser lens 312c and the first condenser lens 311c and becomes substantially parallel light, after which it is reflected by the blue-transmitting and green-reflecting dichroic mirror 329.

In this embodiment, as discussed above, blue excitation light is split into four directions, and can be combined as different colors of light along the optical axis 332.

In FIGS. 8a to 8d, the position where light is incident is shown as a circle, but as mentioned above, if the divergence angles of the emitted light vary with direction, such as when semiconductor lasers are used as the light sources, it is preferable to line up the light sources so that the direction in which the divergence angle increases is the up and down direction in the drawings. Specifically, it is preferable to set the rotational direction to coincide with the direction in which the divergence angle decreases.

When the cut-out ends or openings of the rotary reflecting plates 303 and 304 traverse the light source beam, the light proceeds after being divided into the plurality of optical paths of the above-mentioned colors of light. Therefore, when this lighting device is used together with an image display device or the like, an image of colored light must be in an inactive region or be a white image for one cycle, so there is a decrease in the monochromatic display brightness. Thus, to avoid a decrease in the monochromatic display brightness, the period (time) in which the incident light traverses the cut-out ends is preferably kept to a minimum.

The configuration here of mixing a yellow fluorescent material with an inorganic binder can also be applied to fluorescent materials of other colors.

### Embodiment 4

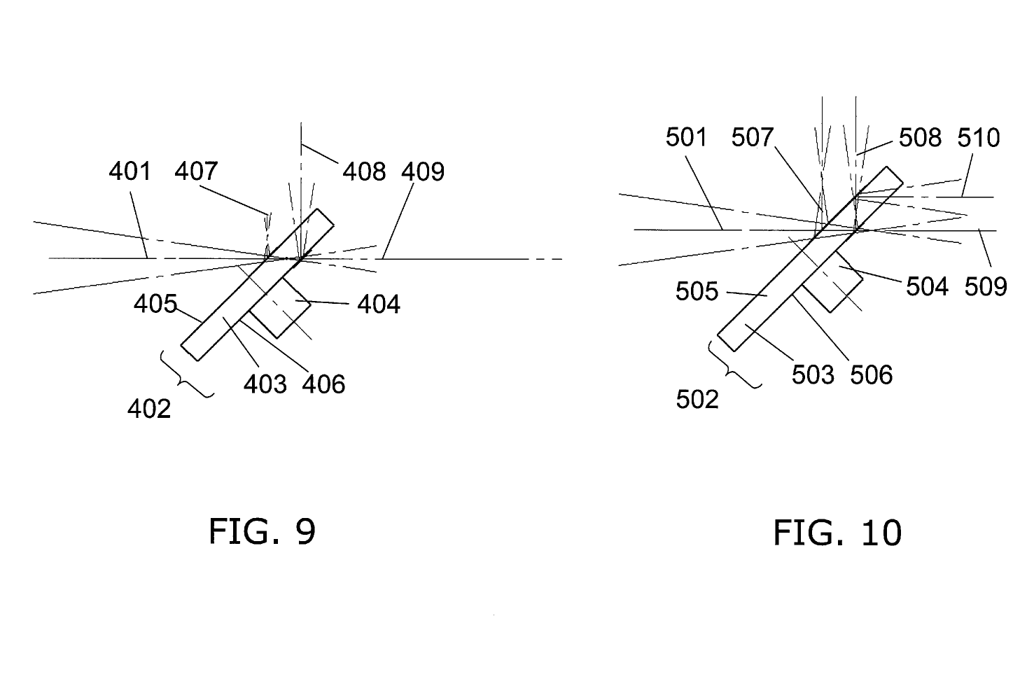

The lighting device pertaining to yet another embodiment of the present disclosure will now be described through reference to FIGS. 9 and 10.

With the lighting device of this embodiment, the configuration of the incident light switching mechanism is different from that in Embodiments 1 to 3 above.

The portion of the incident light switching mechanism that is different from that in the above embodiments will now be described.

In Embodiments 2 and 3 above, the incident light switching mechanism was constituted by two rotary reflecting plates, but in this embodiment, as shown in FIGS. 9 and 10, the same action is obtained by providing a reflective layer to both sides of a glass substrate. FIG. 9 will be described first.

The incident light proceeds along the optical axis 401, and is incident on the incident face 405 of a glass substrate 403 of an incident light switching mechanism 402. The glass substrate 403 is rotated by a motor 404.

The light reflected by the reflective layer provided to a specific portion of the incident face 405 proceeds along the optical axis 407. Meanwhile, of the light incident on the portion of the incident face 405 other than the reflective layer, the light that is incident on a reflective layer provided to the back face 406 of the glass substrate 403 proceeds along the optical axis 408.

Also, of the light incident on the portion of the incident face 405 other than the reflective layer, the light that is incident on the portion of the back face 406 of the glass substrate 403 other than the reflective layer proceeds along the optical axis 409.

Consequently, the incident light switching mechanism 402 shown in FIG. 9 can replace the incident light switching mechanism consisting of two rotary reflecting plates in Embodiments 2 and 3 above.

Next, FIG. 10 will be described. The incident light proceeds along the optical axis 501, and is incident on the incident face 505 of a glass substrate 503 of an incident light switching mechanism 502. The glass substrate 503 is rotated by a motor 504.

The light reflected by the reflective layer provided to a specific portion of the incident face 505 proceeds along the optical axis 507. Meanwhile, of the light incident on the portion of the incident face 505 other than the reflective layer, the light that is incident on a reflective layer provided to the back face 506 of the glass substrate 503 proceeds along the optical axis 508.

Also, of the light incident on the portion of the incident face 505 other than the reflective layer, the light that is incident on the portion of the back face 506 of the glass substrate 503 other than the reflective layer proceeds along the optical axis 509.

Of the light incident on the portion of the incident face 505 other than the reflective layer, the light that is incident on a reflective layer provided to the back face 506 of the glass substrate 503 proceeds along the optical axis 508. Furthermore, the light incident on the reflective layer portion of the incident face 505 is reflected here, while the light incident on the portion of the back face 506 of the glass substrate 503 other than the reflective layer proceeds along the optical axis 510.

Consequently, the former configuration can replace the incident light switching mechanism described in Embodiment 2, and the latter configuration that in Embodiment 3.

### Embodiment 5

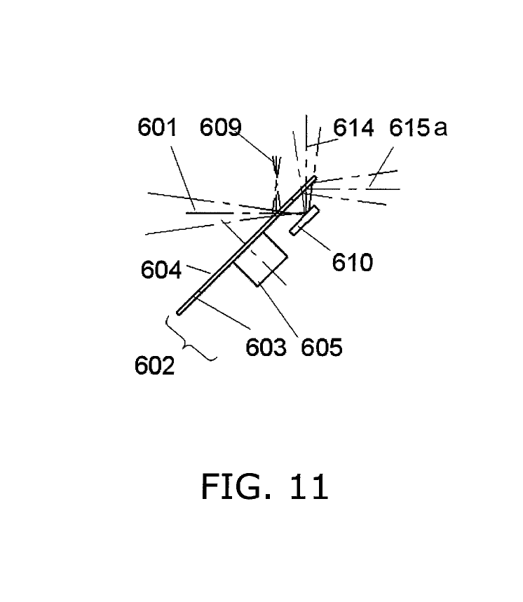

The lighting device pertaining to yet another embodiment of the present disclosure will now be described through reference to FIGS. 11 to 14.

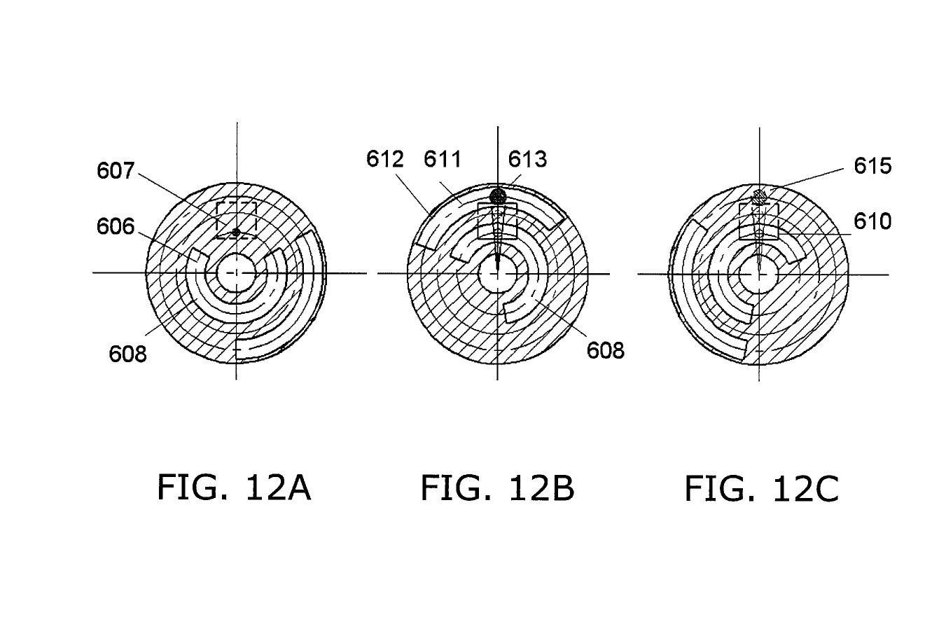

In the description given above, a configuration comprising two rotary reflecting faces was described for when the incident light was split into three or more directions, but in this embodiment the same function is realized with just one rotary reflecting face, which will now be described. More specifically, a configuration in which the incident light is split into three directions will be described through reference to FIGS. 11 and 12.

The incident light proceeds along the optical axis 601, and is incident on the incident face 604 of a glass substrate 603 of an incident light switching mechanism 602. The glass substrate 603 is rotated by a motor 605.

As shown in FIG. 12a, the light is incident on a first periphery 606. At this point the light is incident and reflected at an angle at some position 607 on a reflective layer 607 other than a light transmitting part 608. This allows the reflected light to be guided along the optical axis 609.

Next, when the glass substrate 603 of the incident light switching mechanism 602 rotates, as shown in FIG. 12b, the light is transmitted through the light transmitting part 608 and is incident at an angle on a fixed mirror 610. The light reflected by the fixed mirror 610 is again incident on a second periphery 611 of the glass substrate 603. This time the light is incident on a light transmitting part 612, so it goes through the second periphery 611 and proceeds directly along the optical axis 614.

Next, when the glass substrate 603 of the incident light switching mechanism 602 rotates, as shown in FIG. 12c, the light is transmitted through the light transmitting part 608 and is incident at an angle on the fixed mirror 610.

The light reflected by the fixed mirror 610 is incident on the second periphery 611 of the glass substrate 603, but is incident and reflected at an angle at some position 615 where the light beam hits on the reflective layer other than the light transmitting part 608. Consequently, the reflected light can proceed along the optical axis 615a.

In this embodiment, as discussed above, a fixed mirror is used along with a rotary reflecting plate, which has the same function as with the configuration described in Embodiment 2, in which there were two rotary reflecting plates. It is particularly favorable for the incident light beam at the incident position to be small in size.

As described above, while the interface portion between the reflecting face and the transmitting face is being traversed by a light beam, the optical path is divided into a plurality of paths, so the output light is a mixed color. Thus, with a projection type of image display, during this time the duration of display of each single color is reduced and the display ends up being darker.

This mixed color period (time) is determined by the length of the arc of the fan shape including both ends in the peripheral direction of the light beam around the rotational center of the rotary plate, or in other words, by the angle center angle formed by two straight lines extending in the radial direction including the size of the light beam from the rotational center of the rotary plate. Thus, as shown in FIG. 12c, the convergence position is preferably set according to the size of the incident light beam so that the center angle (first angle) seen from the rotational center of the light beam at a position closer to the rotational center will be substantially equal to the center angle (second angle) seen from the rotational center of the light beam at a position farther away from the rotational center.

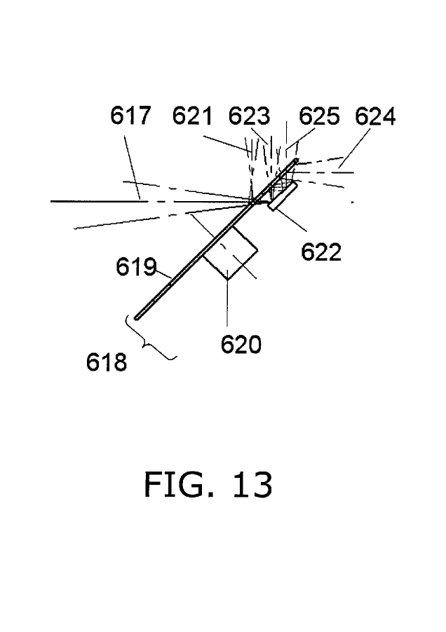

Furthermore, the configuration shown in FIG. 13 is also one in which a single rotary reflecting face is used together with a fixed mirror, and is one in which the incident light is divided into four optical paths.

In principle, with the configuration shown in FIGS. 11 to 12c, the same effect could be obtained by providing a third periphery on the outside of the second periphery 611, and providing a part of this with a portion that transmits incident light. However, this would result in a longer optical path from the position where the light is first reflected toward the optical axis 621 until it is reflected toward the optical axis 624, and if the incident light diverges too much, this divergence can be suppressed by making the fixed mirror 622 a curved mirror having a converging action.

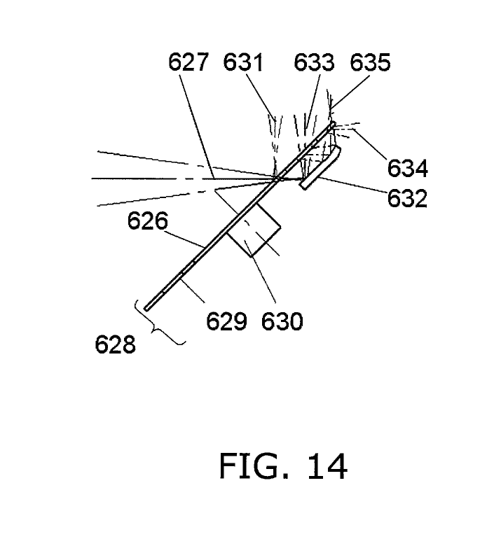

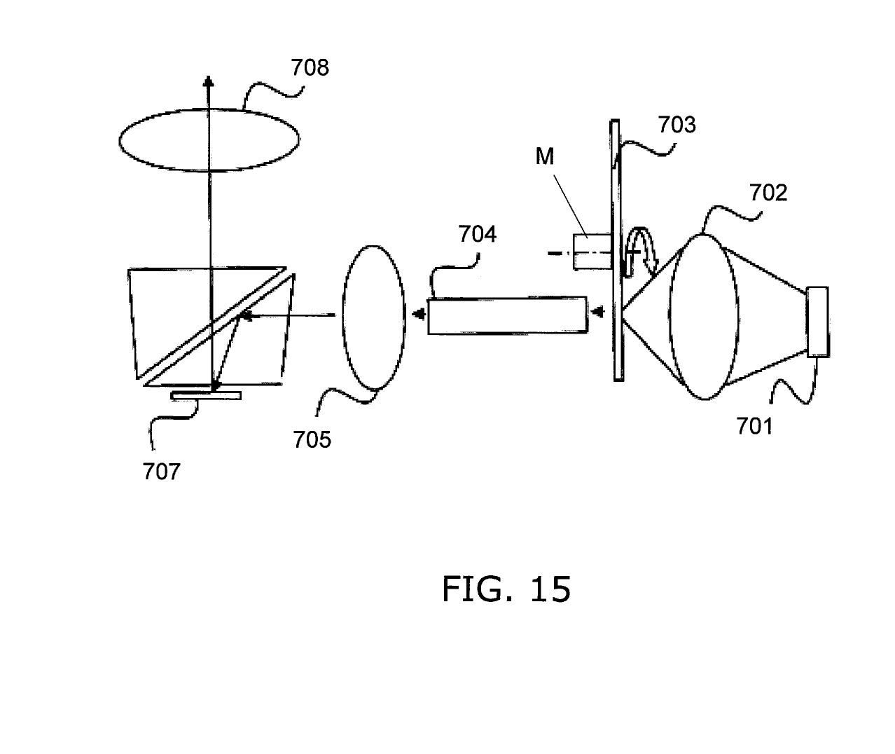

Alternatively, as shown in FIG. 14, a configuration which suppresses divergence of the incident light, is compact, and with which there is no interference between optical paths can be realized by providing a curved face to the fixed mirror 632 and giving it a converging action.

Constitution and Effect

The lighting device for solving the above problem comprises at least a light source and a rotary reflecting member disposed at an angle to light that is incident from the light source. The rotary reflecting member has a portion that reflects light that is incident in the peripheral direction in along the rotational direction of this member (first region), and a portion that does not reflect (second region).

Also, the rotary reflecting member may have a first reflective member and a second reflective member provided coaxially. Further, a reflecting mirror may be provided at the incident position of incident light not reflected by the above-mentioned rotary reflecting member.

A fluorescent material may be disposed along at least one optical path of the light emitted from the rotary reflecting member. This fluorescent material may be constituted so that is applied in an annular shape including the light source irradiation position on a highly reflective disk, and is rotated by a motor.

Alternatively, the fluorescent material may be formed by applying a mixture of a fluorescent material and an inorganic binder over a substrate, and thermally linking it to a heat diffuser. Or, a chip may be obtained by baking and solidifying a fluorescent material, and thermally linking to a heat diffuser. A reflective layer is preferably provided to the rear face of the fluorescent material. This improves the reflected light takeoff efficiency.

Further, a light diffuser may be provided to the front or back face of the rotary reflecting member. This is particularly effective when a blue optical path is set to the optical path of light reflected by the rotary reflecting member.

The rotary reflecting member may be a metal material with excellent thermal conductivity, with a cut-out formed as a portion that does not reflect light.

The rotary reflecting member may be a reflective layer provided partially on a transparent substrate.

The convergence position of incident light may be determined so that the center angle formed by the size of a light beam seen from the rotational center of the rotary reflecting member at the position where the rotary reflecting member and the incident light intersect is minimized. Also, the convergence position of incident light may be set so that when incident light intersects the rotary reflecting plate a plurality of times to that end, the center angles formed by the sizes of the light beams seen from the rotational center are substantially equal.

The light from the light source may be converged on or near the reflecting member.

With a configuration in which a plurality of rotary reflecting members are used, the light from the light source may be converged between or near a plurality of rotary reflecting members.

The light reflected by the reflecting mirror disposed at the incident position of incident light not reflected by the rotary reflecting member may be incident on the back face of the rotary reflecting member. Also, a member having the action of converging incident light on this reflecting mirror may be used.

The light source may be a laser, and may be an LED.

In particular, a plurality of these light sources may be used together. In particular, when the light source is a laser, it may be a semiconductor laser, and there may be a relation such that the direction in which the divergence angle decreases for light emitted by this semiconductor laser substantially coincides with the rotational direction of the rotary reflecting member.

This projection type of image display device comprises the above-mentioned lighting device, an illumination light combining optical system that directs light from the lighting device at a fluorescent material and combines the light rays emitted from the fluorescent material, a relay optical system that guides light emitted from the illumination light combining optical system to an image display element, an image display element that receives light emitted from the relay optical system and modulates incident light according to a signal from the outside, and a projection optical system that enlarges and projects an image on the image display element.

It should go without saying that this projection type of image display device can also be applied to a constitution in which a plurality of rotary reflecting plates are used.

With the above constitution, light from a light source can be emitted in different directions at regular time intervals. This affords a lighting device with which there is provided a fluorescent material or the like that emits light of different colors upon receiving light from a light source for each of several divided optical paths, and the light beams can be successively switched by optically combining this light. Furthermore, an image display device capable of color display can be provided by equipping this lighting device with an image display device and a projecting lens.

Furthermore, since light of various colors can be dispersed by reflecting and transmitting the desired light at the rotary reflecting member, the generation of a large amount of heat in a single member can be avoided. As a result, the adverse effects of heat can be prevented.

In particular, since transparent glass or a metal plate having a partial cut-out and having excellent reflectivity is given a reflective coating, and the system switches between transmission and reflection of light, optical separation can be achieved without any pronounced heat generation. Thus, a high-output device can be obtained with no concerns about motor reliability and so forth.

### INDUSTRIAL APPLICABILITY

The present disclosure can be widely applied to the production and use of lighting devices and projection image display devices that make use of these lighting devices.

### GENERAL INTERPRETATION OF TERMS

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of the lighting device. Accordingly, these terms, as utilized to describe the technology disclosed herein should be interpreted relative to the lighting device.

The term “configured” as used herein to describe a component, section, or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicants, including the structural and/or functional concepts embodied by such feature(s). Thus, the foregoing descriptions of the embodiments according to the present invention are provided for illustration only, and not for the purpose of limiting the invention as defined by the appended claims and their equivalents.

1. A lighting device, comprising:
a light source; and
a rotary reflecting member comprising a first region that reflects light and a second region that does not reflect light;
wherein the rotary reflecting member is disposed at an angle such that an incident face of the reflecting member coincides with light from the light source and rotates in respect to the light.

2. The lighting device according to claim 1, further comprising:
a fluorescent component disposed along at least one optical path of light from the rotary reflecting member.

3. The lighting device according to claim 2, wherein:
the fluorescent component includes a highly reflective disk, and a fluorescent material applied over the highly reflective disk in an annular shape including a portion that is irradiated by the light source; and
the lighting device further includes a motor that rotates the highly reflective disk.

4. The lighting device according to claim 2, wherein:
the fluorescent component further includes a substrate coated by a mixture comprising a fluorescent material and an inorganic binder; and
the lighting device further includes a heat diffuser thermally connected to the substrate.

5. The lighting device according to claim 2, wherein:
the fluorescent component includes a clump of fluorescent material; and
the lighting device further includes a heat diffuser thermally connected to the fluorescent component.

6. The lighting device according to claim 2, wherein:
the fluorescent component includes a substrate coated with a fluorescent material and a reflective layer on the rear face of the substrate.

7. The lighting device according to claim 1, wherein:
the rotary reflecting member includes a first reflective member and a coaxial second reflective member.

8. The lighting device according to claim 1, further comprising:
a reflecting mirror at a position incident to incident light that has passed through the rotary reflecting member.

9. The lighting device according to claim 1, further comprising:
a light diffuser provided at a front or a back face of the rotary reflecting member.

10. The lighting device according to claim 1, wherein:
a blue light path is set along an optical path of light reflected by the rotary reflecting member.

11. The lighting device according to claim 1, wherein:
the rotary reflecting member includes a metal with excellent thermal conductivity, and
the second region includes a cut-out.

12. The lighting device according to claim 1, wherein:
the rotary reflecting member further includes a transparent substrate and a reflective layer over a portion of the transparent substrate.

13. The lighting device according to claim 1, further comprising:
a convergence position at which light converges at the rotary reflecting member; and
a center angle formed by the flux of incident light as seen from a rotational center of the rotary reflecting member;
wherein the convergence position is configured to minimize the center angle.

14. The lighting device according to claim 1, further comprising:
a plurality of positions at which incident light intersects with the rotary reflecting member;
a first angle formed by a first light flux intersecting the rotary reflecting member; and
a second angle formed by a second light flux intersecting the rotary reflecting member at a position farther away from a rotational center of the rotary reflecting member than the first light flux;
wherein a position that incident light converges is configured such that the first and second angles are substantially equal.

15. The lighting device according to claim 13, wherein:
the light from the light source converges on or near the rotary reflecting member.

16. The lighting device according to claim 13, further comprising:
a plurality of rotary reflecting members;
wherein the light from the light source converges between or near the plurality of rotary reflecting members.

17. The lighting device according to claim 8, wherein:
the reflecting mirror is configured such that reflected light will be incident on the back face of the rotary reflecting member.

18. The lighting device according to claim 8, wherein:
the reflecting mirror is configured to converge incident light.

19. The lighting device according to claim 1, wherein:
the light source includes a laser.

20. The lighting device according to claim 19, wherein:
the light source includes a semiconductor laser.

21. The lighting device according to claim 20, wherein:
the semiconductor laser is configured to emit light with an elliptical cross section including a major axis and a minor axis, and
the orientation of the minor axis and the rotational direction of the rotary reflecting member are substantially aligned on the surface of the rotary reflecting member.

22. The lighting device according to claim 1, wherein:
the light source includes an LED.

23. A projection image display device, comprising:
the lighting device according to claim 1;
an illumination light combining optical system configured to direct light from the lighting device to a fluorescent material, and combine the light rays emitted from the fluorescent material;
a relay optical system configured to guide light emitted from the illumination light combining optical system to an image display element;
the image display element configured to receive light emitted from the relay optical system and modulate incident light according to a signal; and
a projection optical system that enlarges and projects an image on the image display element.
